(19) United States
(12) Patent Application Publication
(10) Pub. No.: US 2013/0212515 A1
(43) Pub. Date: Aug. 15, 2013

(54) USER INTERFACE FOR TEXT INPUT

(71) Applicant: Syntellia, Inc., (US)

(72) Inventor: Kostas Eleftheriou, San Francisco, CA (US)

(73) Assignee: Syntellia, Inc., San Francisco, CA (US)

(21) Appl. No.: 13/747,700

(22) Filed: Jan. 23, 2013

Related U.S. Application Data
(60) Provisional application No. 61/598,163, filed on Feb. 13, 2012.
(60) Provisional application No. 61/665,121, filed on Jun. 27, 2012.

(51) Int. Cl. G06F 3/0488

(52) U.S. Cl. CPC G06F 3/04883
USPC 715/773

(57) ABSTRACT

A user interface allows a user to input text, numbers and symbols in to an electronic device through a touch sensitive input and make edits and correction to the text with one or more swipe gestures. The system can differentiate the swipes and perform functions corresponding to the detected swipes based upon swipe direction, number of fingers used in the swipe and the location of the swipes on the touch sensitive input.

### CROSS REFERENCE TO RELATED APPLICATIONS

This application claims priority to U.S. Provisional Patent Application No. 61/598,163, “User Interface For Text Input” filed Feb. 13, 2012 and U.S. Provisional Patent Application No. 61/665,121, “User Interface For Text Input” filed Jun. 27, 2012. The contents of U.S. Provisional Patent Application Nos. 61/598,163 and 61/665,121 are hereby incorporated by reference in their entirety.

### FIELD OF INVENTION

This invention relates to user interfaces and in particular to text, number and symbol input and correction on touch screen input devices.

### BACKGROUND OF THE INVENTION

The present invention relates to devices capable of recording finger movements. Such devices include, for example, computers and phones featuring touch screens, or other recording devices able to record the movement of fingers on a plane or in three dimensional spaces.

A number of devices where finger interaction is central to their use have recently been introduced. They include mobile telephones (such as the Apple iPhone, the Samsung Galaxy 5), tablet computers (such as the Apple iPad, or the Blackberry Playbook), as well as a range of mobile computers, PDAs and satellite navigation assistants. The growth in the use of smartphones and tablets in particular has accelerated the introduction of touch screen input for many users and uses.

In some devices featuring a touch screen, it is common for systems to emulate a keyboard text entry system. The devices typically display a virtual keyboard on screen, with users tapping on the different letters to input text. The lack of tactile feedback in this typing process means that users are typically more error prone than when typing on hardware keyboards.

Most text correction systems feature a combination of auto-correcting and manual-correcting (or disambiguation) functionality. Typically, the system will attempt to guess and automatically correct common typing errors. However, many systems perform the auto-correction without any indication of the corrections. Thus, the user must constantly watch what the system is inputting and make manual corrections if an auto-correction error is detected which can slow the text input process. Other correction systems give the user the ability to reject an automatic correction, or manually select an alternative one.

A common problem with such systems is that the user is required to be precise in their typing, and also to be precise in their operation of the auto- and manual-correcting functionality. Such operation typically requires the user to interact with the touch screen by pressing on specific areas of the screen to invoke, accept, reject, or change corrections. The present invention describes a suite of functions allowing users a much more intuitive, faster and accurate interaction with such a typing system. The resulting system is dramatically more accessible and easy to use for people with impaired vision, compared to other existing systems.

### SUMMARY OF THE INVENTION

The invention describes a device comprising a display capable of presenting a virtual keyboard, an area where the user input text can be displayed and a touch-sensitive controller such as a touch pad or a touch screen. However, in other embodiments, a screen or a touch-sensitive controller may not be required to perform the method of the claimed invention. For example, in an embodiment, the input device can simply be the user's body or hands and a controller that is able to understand the user's finger movements in order to produce the desired output. The output can be either on a screen or through audio signals. For example, the input device may be a camera such as a Microsoft Kinect controller that is directed at the user. The cameras can detect the movement of the user and the output can be transmitted through speakers or other audio devices such as headphones. Optionally, the output can be transmitted through an output channel capable of audio playback, such as speakers, headphones, or a hands-free ear piece.

In some embodiments, the device may be a mobile telephone or tablet computer. In such cases, the text display and touch-sensitive controller may both be incorporated in a single touch-screen surface or be separate components. With the inventive system, the user controls the electronic device using the touch-sensitive controller in combination with performing a number of“gestures” which are detected by the touch-sensitive controller. Some existing systems are capable of detecting gestures input to a touch-sensitive controller such as U.S. Patent Publication No. US 2012/0011462, which is hereby incorporated by reference.

The inventive system may be programmed to recognize certain gestures including:

1. Tapping at different areas of the screen and different quantities of taps. For example, the system can distinguish between a single tap, a double tap, a triple tap, a quadruple tap, etc. The multiple taps can be by the same finger or multiple fingers such as two finger taps, three finger taps, four finger taps, etc. In yet another embodiment, the system can detect multiple taps with different fingers. For example, a first tap with a first finger, a second tap with a second finger, a third tap with a third finger and a fourth tap with a fourth finger. These multiple taps, can also include any variation or sequence of finger taps. For example, a first tap with a first finger, a second tap with a second finger, a third tap with a first finger and a fourth tap with a third finger. The disclosed tapping can be described as “tap gestures.”
2. Swiping which can include touching the screen and moving the finger across the screen in different directions across the screen and a different locations on the screen. Swiping can also be performed using one or more fingers. The system can differentiate these different swipes based upon the number of fingers detected on the screen. The system may be able to distinguish between linear swipes and rotational swipes. Linear swipes can be detected as a touching of the input at a point a movement while maintaining contact in a specific direction which can be up, down, left, right and possibly diagonal directions as well such as: up/right, up/left, down/right and down/left. Rotational swipes can be detected as a touching of the input at a point and a circular movement while maintaining contact. The system can detect clockwise and counter-clockwise rotational swipes.
3. The system may also detect combinations of gestures. For example, a linear swiping gesture as described above followed by holding the finger on a screen for a short time before releasing. The holding of the finger on the screen can be described as a “hold gesture” and the combination of the swipe and hold can be described as a “swipe and hold” gesture.

Typically, the user will use tap gestures to type the individual letters used to create words on a virtual keyboard, emulating a typing movement. Unlike most virtual keyboards, there may not be any control keys such as space, backspace and shift. Instead these functions can be performed using other touch gestures. In an embodiment, all tapping, swipes and other detected gestures must take place within the designated keyboard area of the touch input device which can be the lower part of a touch screen where a virtual keyboard and editing information may be displayed.

The inventive system can also correct the user's text input as he types, using an algorithm to identify and analyse typing errors. When the system detects the user may have made such an error, the correction algorithm will provide alternative suggestions on an optical display or via audio feedback.

The user can navigate through the correction algorithm suggestions using a set of defined swipe and swipe-and-hold gestures. Additionally, the user may be able to insert symbol characters, and to format the text, using either swipe and/or swipe and hold gestures. Typically, all gestures will be restricted to some area of the touch surface, most commonly the area of the onscreen keyboard. However, in an embodiment, the inventive text input system can detect gestures on any portion of the touch screen input device. The present invention will thus provide a comprehensive text input system incorporating spelling / typing check, format, and advanced input, by detecting applicable gestures.

### BRIEF DESCRIPTION OF THE DRAWINGS

FIG. 1 illustrates an electronic device having a touch screen keyboard;

FIG. 2 illustrates a block diagram of mobile device components;

FIGS. 3-13 illustrate examples of text input and letter/word correction using embodiments of the inventive system;

FIG. 14 illustrates an example of letter capitalization with an embodiment of the inventive system;

FIG. 15 illustrates an example of punctuation mark input with an embodiment of the inventive system;

FIGS. 16-17 illustrate examples of symbol input with embodiments of the inventive system;

FIGS. 18-19 illustrate examples of punctuation mark corrections with an embodiment of the inventive system;

FIGS. 20-21 illustrate examples of keyboard alterations with embodiments of the inventive system;

FIG. 22 illustrates examples of hardware button functions used with embodiments of the inventive system; and

FIG. 23 illustrates an example of cameras used to detect gestures used with embodiments of the inventive system.

### DETAILED DESCRIPTION OF THE INVENTION

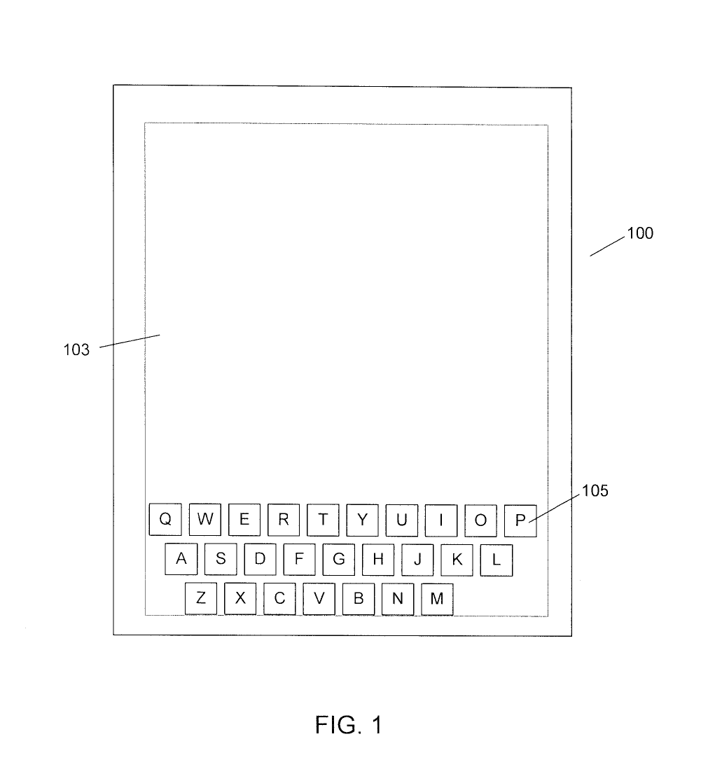

With reference to FIG. 1, a top view of an exemplary electronic device 100 is illustrated that implements a touch screen-based virtual keyboard 105. The illustrated electronic device 100 includes an input/display 103 that also incorporates a touch screen. The input/display 103 can be configured to display a graphical user interface (GUI). The GUI may include graphical and textual elements representing the information and actions available to the user. For example, the touch screen input/display 103 may allow a user to move an input pointer or make selections on the GUI by simply pointing at the GUI on the input/display 103.

The GUI can be adapted to display a program application that requires text input. For example, a chat or messaging application can be displayed on the input/display 103 through the GUI. For such an application, the input/display 103 can be used to display information for the user, for example, the messages the user is sending, and the messages he or she is receiving from the person in communication with the user. The input/display 103 can also be used to show the text that the user is currently inputting in text field. The input/display 103 can also include a virtual “send” button, activation of which causes the messages entered in text field to be sent.

The input/display 103 can be used to present to the user a virtual keyboard 105 that can be used to enter the text that appears on the input/display 103 and is ultimately sent to the person the user is communicating with. The virtual keyboard 105 may or may not be displayed on the input/display 103. In an embodiment, the system may use a text input system that does not require a virtual keyboard 105 to be displayed.

If a virtual keyboard 105 is displayed, touching the touch screen input/display 103 at a “virtual key” can cause the corresponding text character to be generated in a text field of the input/display 103. The user can interact with the touch screen using a variety of touch objects, including, for example, a finger, stylus, pen, pencil, etc. Additionally, in some embodiments, multiple touch objects can be used simultaneously.

Because of space limitations, the virtual keys may be substantially smaller than keys on a conventional computer keyboard. To assist the user, the system may emit feedback signals that can indicate to the user what key is being pressed. For example, the system may emit an audio signal for each letter that is input. Additionally, not all characters found on a conventional keyboard may be present or displayed on the virtual keyboard. Such special characters can be input by invoking an alternative virtual keyboard. In an embodiment, the system may have multiple virtual keyboards that a user can switch between based upon touch screen inputs. For example, a virtual key on the touch screen can be used to invoke an alternative keyboard including numbers and punctuation characters not present on the main virtual keyboard. Additional virtual keys for various functions may be provided. For example, a virtual shift key, a virtual space bar, a virtual carriage return or enter key, and a virtual backspace key are provided in embodiments of the disclosed virtual keyboard.

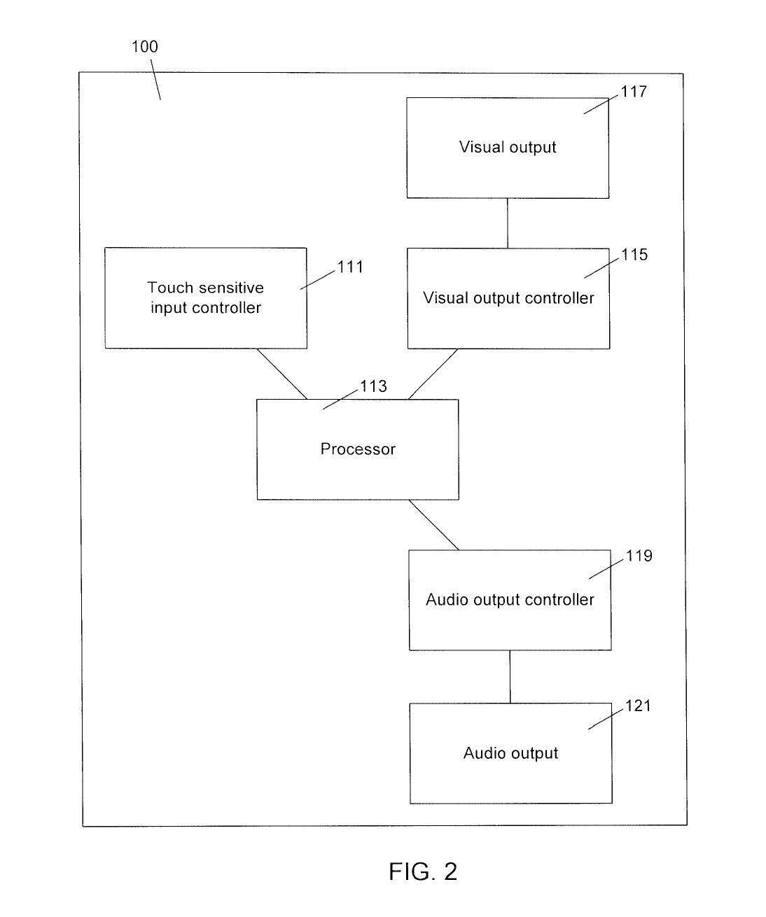

FIG. 2 illustrates a block diagram of an embodiment of the device capable of implementing the current invention. The device 100 may comprise: a touch-sensitive input controller 111, a processor 113, a visual output controller 115, a visual display 117, an audio output controller 119 and an audio output 121. In other embodiments the device 100 may include a range of other controllers and other components that may perform a wide number of functions.

### Basic Input

In an embodiment of the current invention, the user will use the device to enter text. The system will assume a virtual keyboard, which may or may not be visible to the user. This will have a map of different “virtual keys” and may resemble the layout of a real keyboard, using QWERTY or some other keyboard layout like DVORAK. The user will be able to input text by applying tap gestures on the different virtual keys. The device will detect the locations of the user's taps or the relative locations of multiple taps and produce typed characters on the screen. The user may tap on the input device one or more times with each tap usually representing one key stroke. The virtual keyboard may or may not be visible on a display or screen.

Once the user has completed typing a word, he will perform a gesture to notify the device that he has completed typing a word. In certain embodiments this will be with a swipe gesture. For example, a swipe from left to right across the screen may indicate that the typed word is complete. In other embodiments the gesture indicating the completed word may be a tap at a specific area of the screen. For example, the specific area of the screen may be where a virtual “space button” is displayed or designated.

The device will process the user's input, and infer the word that the system believes the user most likely intended to enter. This corrective output can be based upon processing the input of the user's taps in combination with heuristics, which could include the proximity to the virtual keys shown on screen, the frequency of use of certain words in the language of the words being typed, the frequency of certain words in the specified context, the frequency of certain words used by the writer or a combination of these and other heuristics. Based upon the described analysis and processing, the device can output the most likely word the user intended to type and replacing the exact input characters that the user had pressed.

The output may be on a screen, projector, or read using voice synthesizer technology to an audio output device.

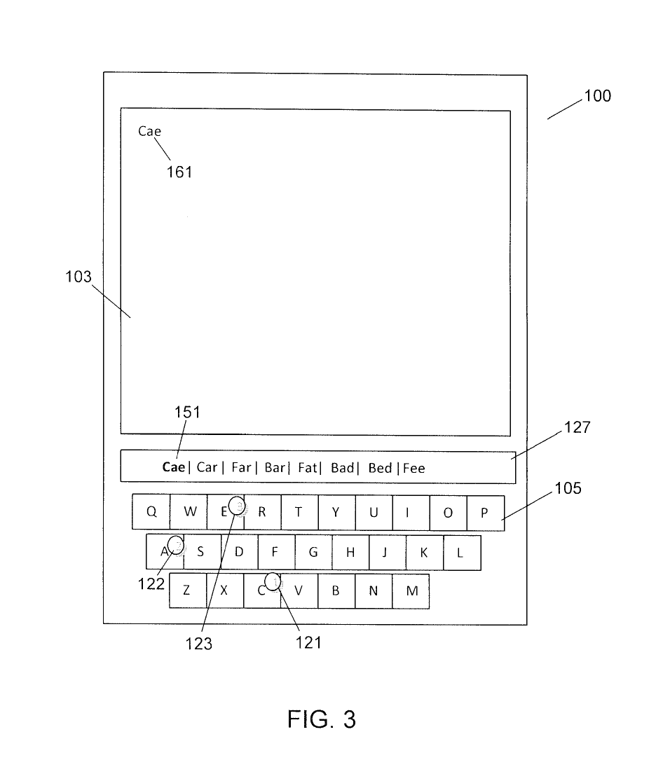

For example, with reference to FIG. 3, the user can use the inventive system and tap at points (1) 121, (2) 122 and (3) 123 which are respectively near letters C, A and E on the virtual keyboard 105. The system may initially display the exact input text “Cae” 125 corresponding the locations and sequence of the tap gestures on the display 103. The system may automatically respond to this input by altering the input text. Because this is the first word of a possible sentence, the first letter “C” may automatically be capitalized. The system may also automatically display possible intended words including: Cae, Car, Far, Bar, Fat, Bad and Fee on a possible word area 127 of the display 103. The current suggested word

“Cae” may be indicated by bolding the text as shown or by any other indication method such as highlighting, flashing the text, contrasting color, etc. In this example, the text “Cae” 151 is bold. Although Cae 151 is not a complete word, the three letters may be the beginning of the user's intended word. The system can continue to make additional suggestions as letters are added or deleted by the user through the input touch screen.

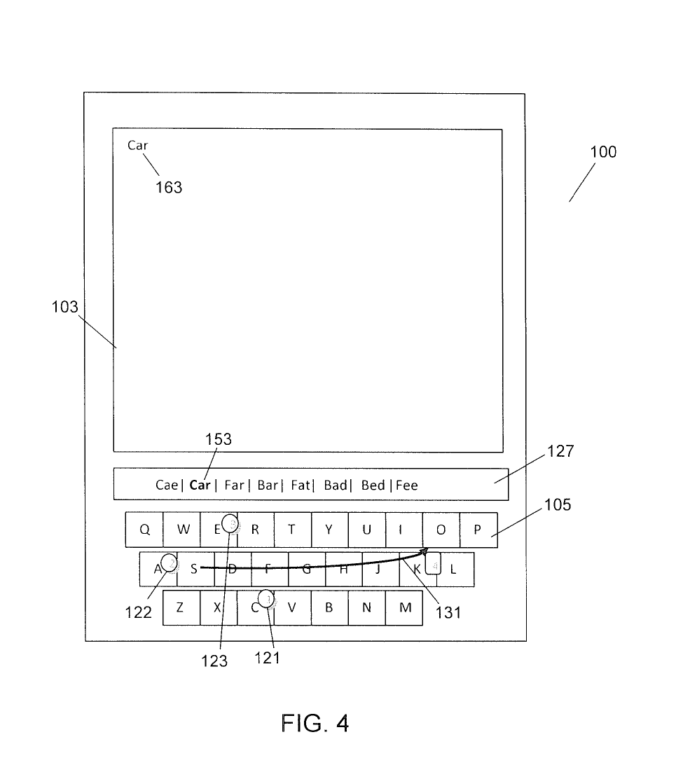

With reference to FIG. 4, in this example, the input text “Cae” may not be what the user intended to write. The user may view or hear the input text and input a command to correct the text. In order to actuate the correction system, the user can perform a swipe gesture that the system recognizes as the gesture for word correction. In an embodiment, the word correction gesture can be a right swipe 131, as indicated by swipe line 4. This right swipe gesture 131 can be recognized by the system as a user request to select the suggested word to the right. The system may respond to the word correction right swipe gesture 131 by replacing the input text “Cae” with the first sequential word in the listing of suggestions which in this example is “Car” 135. The text “Car” can be displayed in bold text in the possible word area 127 to indicate that this is the currently selected replacement word. The system can also replace the text “Cae” with the word “Car” 129 on the display 103.

### Auto-Correction and Manual Correction

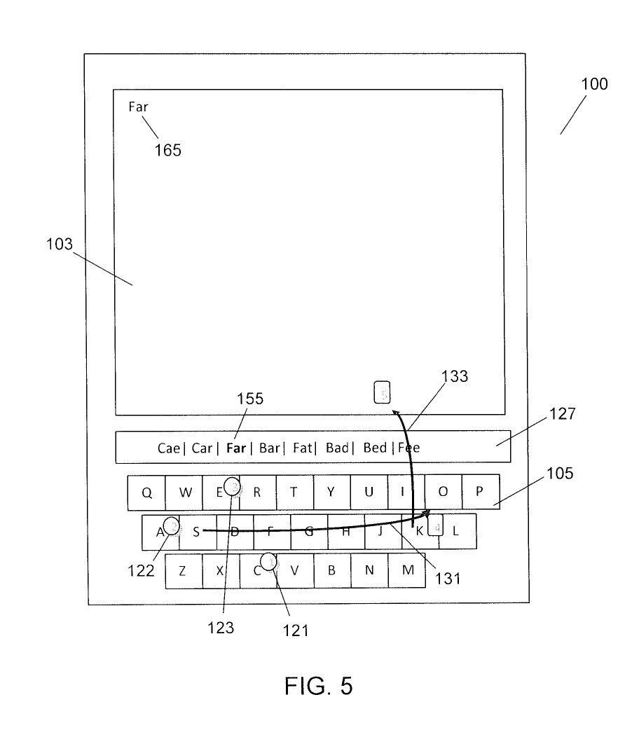

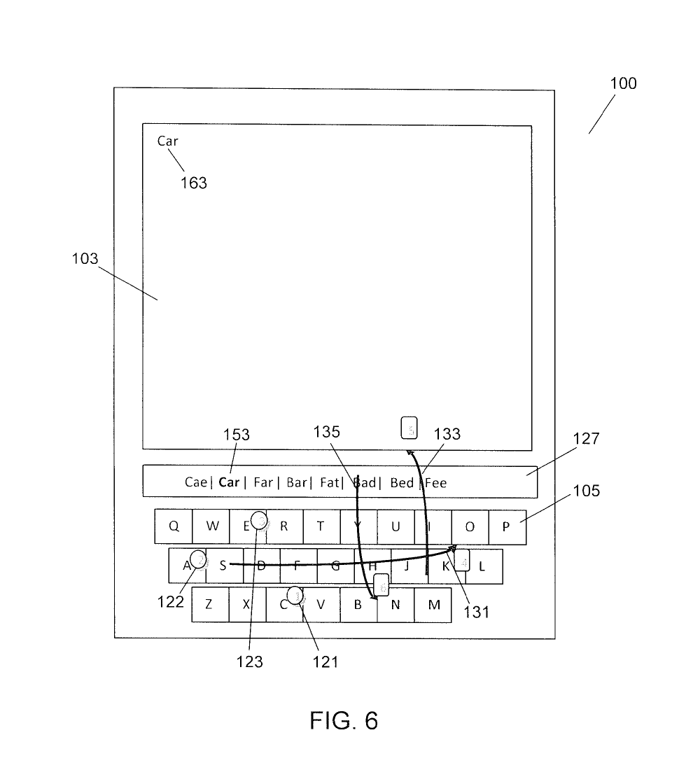

The system can also perform additional auto-corrections and manual corrections. Following on from the previous example shown in FIGS. 3 and 4, FIG. 5 is another example of the behaviour of an embodiment of the system. If the desired word is not “Car”, the user can perform another gesture to select another possible replacement word. In this example, the user's upwards swipe 133 indicated by line 5 may cause the system to replace the first replacement suggestion “Car” with the next suggestion “Far” 155 to the right. Again, the system can respond by displaying the word “Far” 155 in bold text in the possible word area 127 and changing the word “Car” to “Far” in the display 103. This described manual word correction process can proceed if necessary through the sequential listing of words in the possible word area 127. An additional upward swipe performed again would replace the second suggestion with the third suggestion “Bar” to the right and each additional upward swipe can proceed to the next sequential word to the right in the possible word area 127. Conversely with reference to FIG. 6, a subsequent downward swipe 135 indicated by line 6 could cause the system to replace the current suggestion “Far” with the previous one which is the sequential word to the left, “Car” 153. Repeating the downward swipe can result in the system selecting and displaying the next word to the left. If the selected word is the last word on the left side of the possible word area 127, the system can either not change the selected word or scroll around to the right side of the possible word area 127 and then select/display each word to the left with each additional downward swipe.

In other embodiments, the swipes gestures used to change the highlighted word in the possible word area 127 can be a right swipe for forward scrolling and a left swipe for reverse scrolling. In an embodiment, a single swipe in a first direction can cause scrolling to the right or forward and a swipe in a direction opposite to the first direction can cause reverse scrolling to the left. The first direction can be up, down, left, right, any diagonal direction, up/right, up/left, down/right and down/left. In other embodiments, any other type of distinctive gestures or combination of gestures can be used to control the scrolling. Thus, rather than automatically inputting the first suggested word, the system may allow the user to control the selection of the correct word from one or more listing of suggested words which can be displayed in the in the possible word area 127.

In an embodiment, the user can perform a swipe in a distinct direction to the scrolling gestures to con firm a word choice. For example, if up swipes and down swipes are used to scroll through the different words in the displayed group of possible words until the desired word is identified. The user can then perform a right swipe can be used to confirm this word for input and move on to the next word to be input. Similarly, if left and right swipes are used to scroll through the different words in the displayed group of possible words, an up swipe can be used to confirm a word that has been selected by the user.

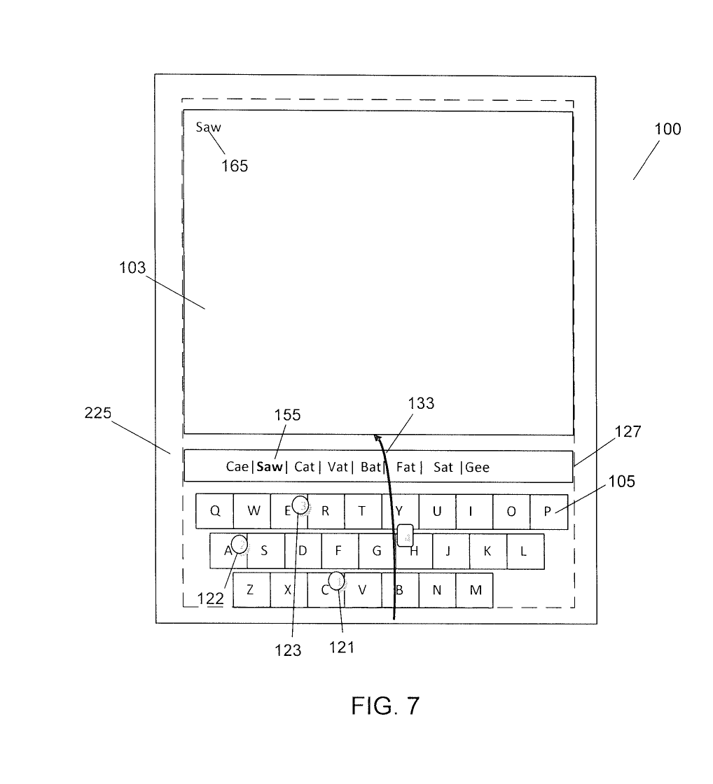

If the system's first suggestion is not what the user desired to input, the user may be able to request the system to effectively scroll through the first set of suggested words as described above. However, if none of the words in the first set of suggested words in the possible word area 127 are the intended word of the user, the system can provide additional sets of suggested words in response to the user performing another recognized swipe gesture. A different gesture can be input into the touch screen 103 and recognized by the system to display a subsequent set or suggested words. For example with reference to FIG. 7, the additional suggestions gesture may be an up swipe 133 from the bottom of the screen 103 in a boundary region 225 to the top of the touch screen display 103 as designated by line 4.

The system will then replace its first listing of suggestions with a second listing, calculated using one or more of the heuristics described above. The second set of suggested words: Cae, Saw, Cat, Vat Bat, Fat, Sat, Gee . . . may be displayed on the touch screen display 103 device where the first listing had been. Because the word correction has been actuated, the second word Saw 165 in the possible word area 127 has been displayed on the screen 103 and Saw 155 is highlighted in bold. Note that the detected input text Cae may remain in the subsequent listing of suggested words in the possible word area 127. The user can scroll through the second listing of words with additional up or down swipes as described. This process can be repeated if additional listings of suggested words are needed.

In order to simplify the detection of swipes starting at the lower edge of the touch screen 103, the system may have a predefined edge region 225 around the outer perimeter of the entire touch screen 103. In an embodiment, the edge region 225 can be defined by a specific measurement from the outer edge of the display 103. For example, the edge region 225 can be a predefined number of pixels in the outer edge of the display 103. For example, the edge region 225 may be a distance between about 10-40 pixels or any other suitable predefined distance, such as 0.5 inches that defines the width of the edge region 225 of the display 103. When the system detects an upward swipe commencing in the predefined edge region 225 while in the word correction mode, the system can replace the current set of suggested works in the suggested word area 127 with a subsequent set of suggested words. Subsequent up swipes from the edge region 225 can cause subsequent sets of suggested words to be displayed. In an embodiment, the system may cycle back to the first set of suggested words after a predefined number of sets of suggested words have been displayed. For example, the system may cycle back to the first set of suggested words after 3, 4, 5 or 6 sets of suggested words have been displayed. In other embodiments, the user may input a reverse down swipe gesture that ends in the edge region to reverse cycle through the sets of suggested words.

Note that the sequence of gestures used to scroll through the displayed possible words described with reference to FIGS. 4-6 is different than the gesture used to change the listing of displayed possible words described with reference to FIG. 7. The sequence for scrolling through the displayed possible words in the described examples is letter input taps followed by a right swipe to start the manual word correction process. Once the word selection is actuated, the user can perform up or down swipes to sequentially scroll through the listing of words. In contrast, an immediate up swipe can actuate the manual word correction process by changing the listing of displayed possible words in the possible word area 127. With the second listing of words displayed in the possible word area 127, the user can sequentially scroll through the listing of words with up or down swipes as described above.

As soon as the user agrees with the system suggestion, the tapping process for inputting additional text can be resumed. In an embodiment, the tapping can be the gesture that indicates that the displayed word is correct and the user can continue typing the next word with a sequence of letter tapping gestures. The system can continue to provide sets of words in the possible word area 127 that the system determines are close to the intended words.

In other embodiments, the system may require a confirmation gesture to indicate that the displayed word is correct before additional words can be input. This confirmation gesture may be required between each of the input words. In an embodiment, a word confirmation gesture may be an additional right swipe which can cause the system to input a space and start the described word input process for the next word. The confirmation gesture can be mixed with text correction gestures so that the system can recognize specific sequences of gestures. For example, a user may type “Cae” 161 as illustrated in FIG. 3. The user can then right swipe 131 to actuate the word correction function and the system can change “Cae” to “Car” 103 in the display as illustrated in FIG. 4. The user can then up swipe 133 to change “Car” to “Far” 165. The user can then perform another right swipe to confirm that “Far” is the desired word and the system can insert a space and continue on to the next word to be input.

The examples described above demonstrate that the user is able to type on a touch screen in a way that resembles touch typing on hardware keyboards. The inventive system is able to provide additional automatic and manual correct functionality to the user's text input. The system also allows the user to navigate between different auto-correct suggestions with single swiping movements.

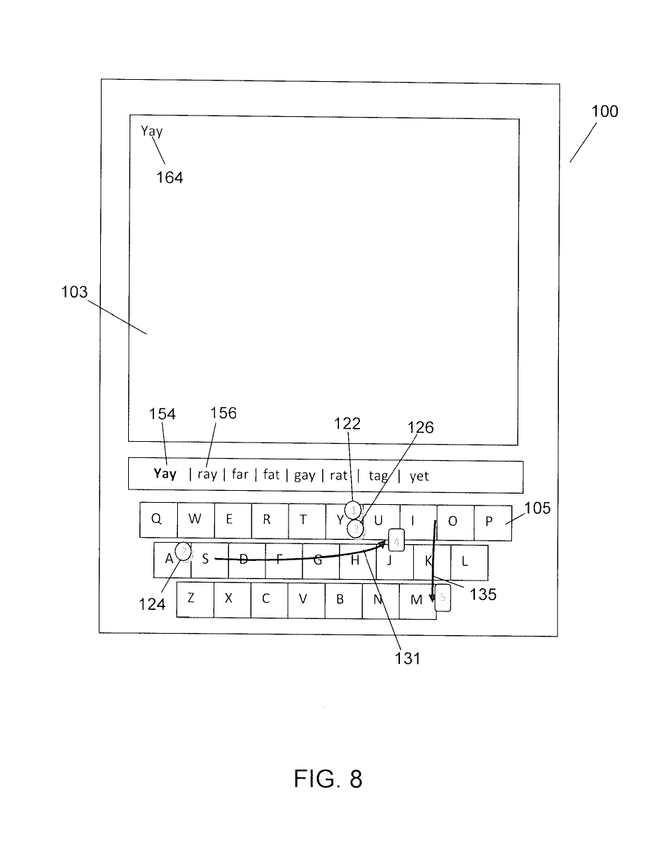

In an embodiment, the inventive system may also allow the user to manually enter custom text which may not be recognized by the system. This can be illustrated in FIG. 8. The user, in this example, has tapped the word YAY. In the illustrated example, the user has input a first tap on “Y” 122, a second tap on “A” 124 and a third tap on “Y” 126. Upon the user's selection of a right swipe designed by line 4 which may initiate the correction mode, the system will auto-correct the input to the word “ray” 156, the next sequential word in the possible word area 127 which may be the closes match found by the system dictionary algorithm. The user could then use a single downward swipe 135 designated by line 5 to revert to the originally input text Yay 164 on the display 103 and Yay 154 listed in the possible word area 127. In an embodiment, the right swipe 131 and then the down swipe 135 could be applied in one continuous multi-direction swipe commencing in a right direction and then changing to a down-bound direction. In certain embodiments of the system it may be possible to initiate a special state of the system in which the auto correct functionality is easily enabled and disabled allowing the user to type without the system applying any corrections with any confirmation swipes.

Virtual Scroll wheel

The above examples show the effects of up or down swipes to navigate between words in a list of different system generated suggestions/corrections through the user input, including the exact input of the user. In other embodiments of the system, additional gestures can be used that enables a faster navigation between these suggestions. This feature can be particularly useful where there are many items to choose from.

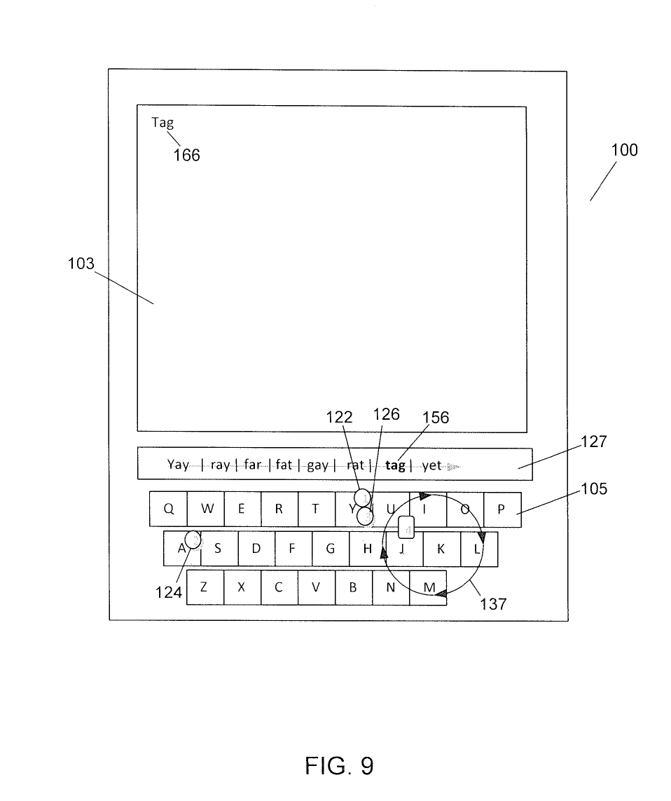

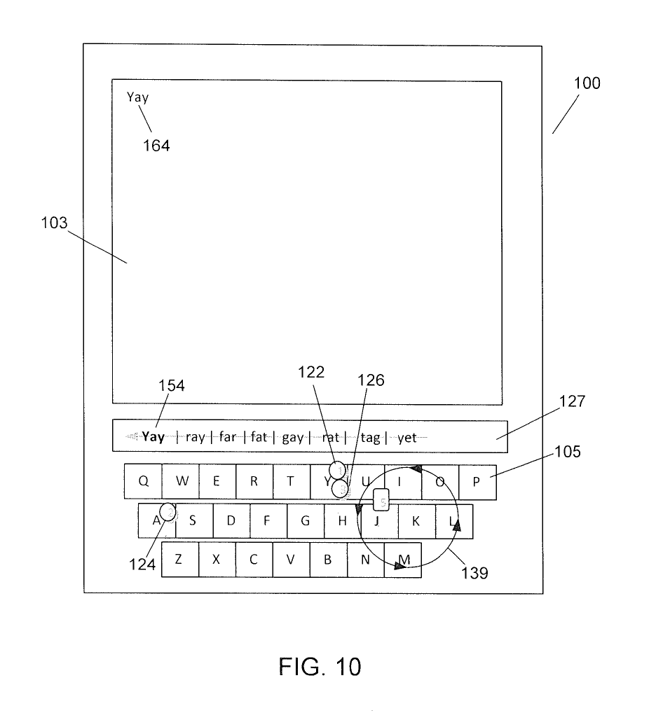

In an embodiment, the user to emulate a circular swipe motion on the screen which can be clockwise or anti-clockwise. For example as illustrated in FIG. 9, a clockwise circular motion 137 designed by circle 4 can have the effect of repeating the effects of one or more upward swipes and result in a forward scrolling through the listing of suggested words in the possible word area 127. In this example, the user may have tapped the word “Yay” and then made a clockwise circular motion 137 which caused the highlighted word in the possible word area 137 to scroll right. The user has stopped the clockwise circular motion 137 when the word “tag” 156 was in highlighted in bold. The system will simultaneously add the word “Tag” 166 to the display 103. In order to improve the efficiency of the word scrolling, the system may move to each sequential word in the possible word area 127 based upon a partial rotation. As illustrated in FIG. 10, a counter-clockwise motion 139 designed by circle 5 can have the effect of repeating the effects of one or more downward swipes and result in a backward scrolling through the listing of suggested words in the possible word area 127. The speed of the repetition or cycling to the left through the words in the listing of suggested words could be proportionate to the speed of cycling. In this example, the user has stopped at the word Yay 154 in the possible word area 127 and the word Yay 164 is in the display 103.

The system may sequentially highlight words based upon uniform rotational increments. The rate of movement between words could be calculated based on angular velocity. Thus, to reduce the rotational speed and increase accuracy the user can trace a bigger circle or vice-versa “on the fly.” if the speed of switching selected words is based on linear velocity, then the user could get the opposite effect, where a bigger circle is less accurate but faster. Like most gestures of the system, the circular motion can begin at any point of the gesture active area (typically the keyboard). Therefore high precision is not required from the user, while still allowing for fine control. For example, the system may switch to the next word after detecting a rotation of ⅛ rotation, 45° or more of a full circular 360° rotation. The system may identify rotational gestures by detecting an arc swipe having a radius of about ¼ to 3 inches. These same rotational gestures can be used for other tasks, such as moving the cursor back and forth within the text editing area.

### Deletion

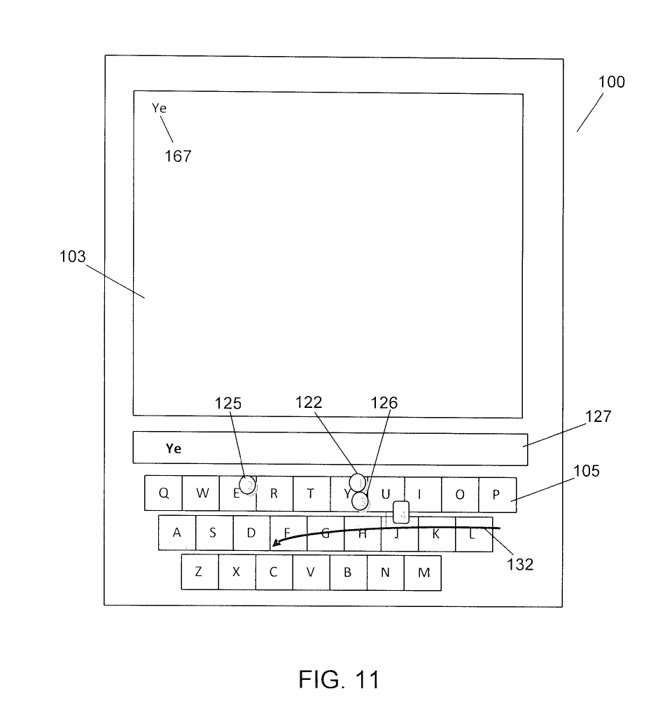

In an embodiment, the present invention allows the user to actuate a backspace delete function through an input gesture rather than tapping a “backspace” key. While the user is typing a word, he or she may tap and input an incorrect letter. The user can notice this error and use a gesture which can be detected by the system and cause the system to remove the letter or effect of the last tap of the user, much as in the effects of a “backspace” button on hardware keyboards. After the deletion, the system will return to the system state as this was before the last tap of the user. In the embodiment shown in FIG. 11, the user has tapped on points (1) 122, (2) 125 and (3) 126 which respectively input “Y”, “e” and “y” before performing a left swipe 132 as designated by line 4. The left swipe 132 can erase the last tapped point (3) 126 resulting in the input text “Ye” 167 in the display and “Ye” in the possible word area 127.

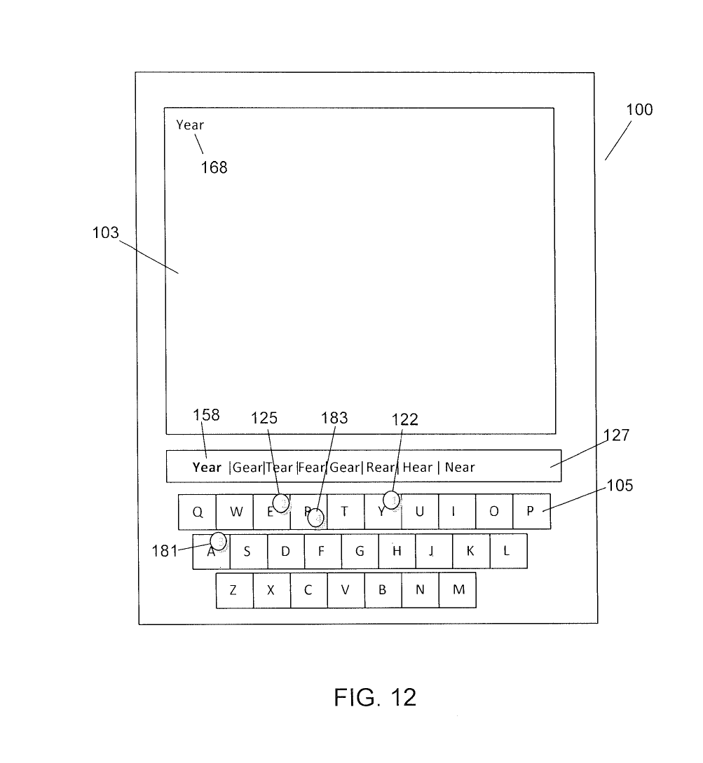

After making the correction described above with reference to FIG. 11, the user may then tap on points (3) 181 and (4) 184 corresponding to the letters “a” and “r” as shown in FIG. 12. The output of the program is similar to this expected if the user had instead tapped on points 1, followed by 3 and 4 corresponding to letters “a” and “r” and resulting in the text “Year”168 in the display 103 and Year 158 highlighted in bold in the possible word area 127.

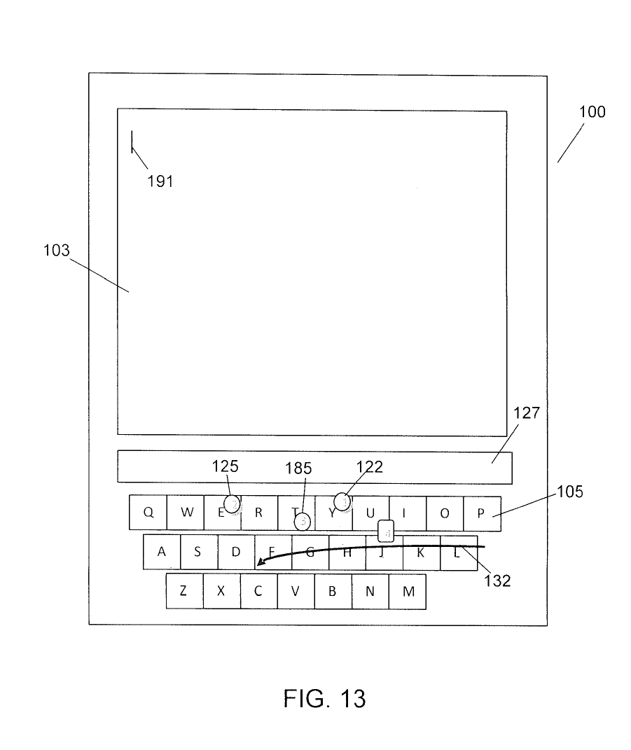

Certain embodiments of the system may enable methods to delete text in a faster way. The effect of the left swipe gesture could be adjusted to delete words rather than characters. FIG. 13 shows an example of such a word erase system. The user has tapped on points (1) 122, (2) 125 and (3) 185 corresponding to the letters Y, E and T respectively. The system may recognize the full word “yet.” Alternatively, the user may input a gesture indicating that the word “yet” is complete and add a space in preparation for the next word. The user may then performed a left swipe gesture 132 shown as line 4, which is recognized by the system and causes the system to cancel all the taps and revert to the state it was after the user's last swipe gesture. In this example, after the word delete, the text Yet has been removed from the screen 103 and the possible word area 127.

In certain embodiments, the inventive system can be used to perform both letter and full word deletion functions as described in FIGS. 11 and 13. In order to distinguish the deletion of a letter or a word, the system may only perform the letter delete function in FIG. 11 when the user has performed a left swipe while in the middle of tapping a word. When the word is not complete and/or not recognized as a full word by the system, each left swipe may have the effect of removing a single text character. However, when the swipe is performed after a complete word has been input, the system can delete the whole of that preceding word. In an embodiment, the system may display a text cursor 191 which can be a vertical line or any other visible object or symbol on the display 103. During the text input, the cursor can visually indicate the location of each letter input. Once a full word has been input, the cursor 191 can place a space after the word either automatically or by a manual gesture such as a word confirmation right swipe described above. As described above, the system can then determine if the letter back space or full word delete function should be applied.

In some embodiments, the system may enable a “continuous delete” function. The user may invoke this by performing a combination gesture of a left swipe and a hold gesture at the end of the left swipe. The function will have the effect of the left swipe, performed repeatedly while the user continues holding his finger on the screen at the end of the left swipe (i.e. while the swipe and hold gesture is continuing). The repetition of deletions could vary with the duration of the gesture; for instance, deletions could happen faster the longer the user has been continuing the gesture. For example, if the delete command is a letter delete backspace, the deletion may start with single character by character deletions and then starting to delete whole words after a predetermined number of full words have been deleted, for example one to five words. If the delete function is a word delete, the initial words may be deleted with a predetermine period of time between each word deletion. However, as more words are deleted, the system can increase the speed which the words are deleted.

### Capitalisation

The system can automatically correct the capitalisation and hyphenation of certain common words. Thus, when a user types a word such as, “atlanta” the system can recognize that this word should be capitalized and automatically correct the output to “Atlanta.” Similarly, the input “xray” could automatically be corrected to “x-ray” and “isnt” can be corrected to “isn't.” The system can also automatically correct capitalisation at the beginning of a sentence.

Additionally, the present invention allows for the user to manually add or remove capitalisation as a word is typed. In an embodiment, this manual capitalization can be done by performing an upwards swipe gesture for changing lower case letters to upper case letters or downward swipes for changing upper case letters to lower case letters. These upward and downward swipe gestures are input as the user is typing a word, changing the case of the last typed character.

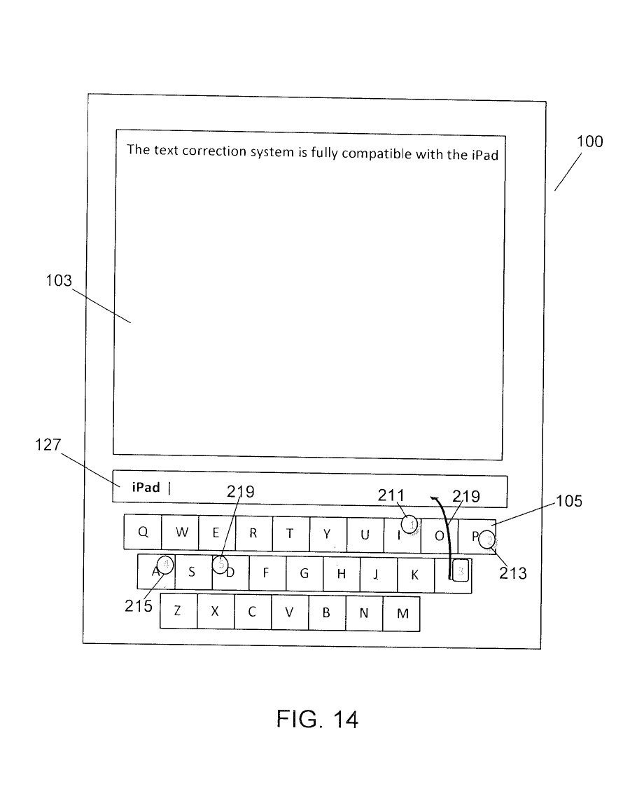

FIG. 14 shows an example of the capitalization function. If the user wants to type the word iPad, he would tap on the relevant points (1) 211 for the letter “i” and (2) 213 for the letter “p.” In order to capitalize the letter “P”, an upwards gesture (3) 219 performed after the second tap at (2) 213. The upward swipe gesture can be from any point on the text input. This would have the effect of capitalising the immediately preceding letter, in a way that resembles the effect of pressing the “shift” button on a hardware keyboard changing the lower case “p” to an upper case “P” in both the display 103 and the possible word area 127. The user can then continue to tap on points (4) 215 for the letter “a”, and (5) 217 for the letter “d” to complete the word, “iPad.”

In an embodiment, the inventive text input system may have a “caps lock” function that is actuated by a gesture and would result in all input letters being capitalized. The “caps lock” function could be invoked with an upwards swipe and hold gesture. The effect of this gesture when performed between taps would be to change the output to remain in capital letters for the preceding and all subsequent taps of the current word being typed and all subsequent letters, until the “caps lock” function is deactivated. In an embodiment, the “caps lock” function can be deactivated with a downwards swipe or a downward swipe and hold gesture.

In another embodiment, a different implementation of the capitalisation function could emulate the behaviour of a hardware “caps lock” button for all cases. In these embodiments, the effect of the upwards swipe performed in between taps would be to change the output to be permanently capital until a downwards swipe is performed. The inventive system may be able to combine the capitalization function with the auto-correct function, so that the user may not have to type exactly within each of the letters, with the system able to correct slight position errors.

### Symbol Entry

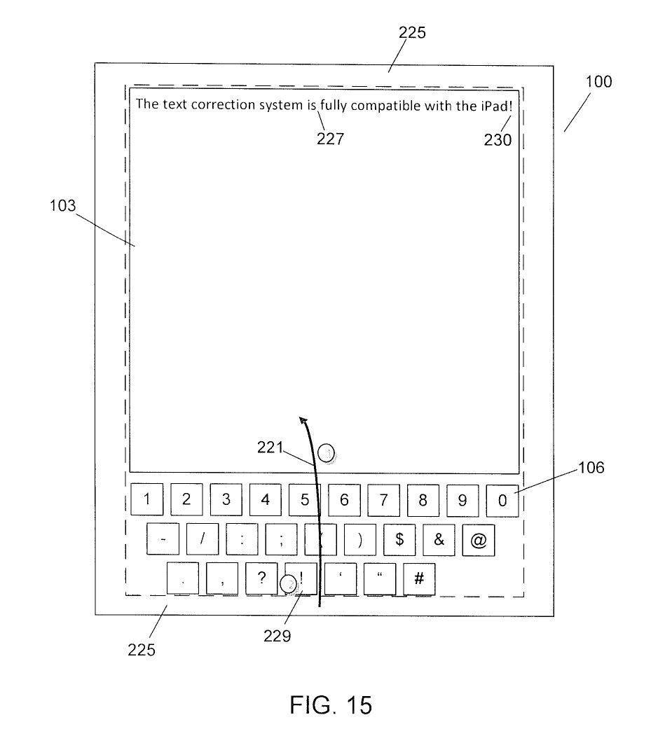

The present invention may include systems and methods for inputting symbols including: punctuation marks, mathematical, emoticons, etc. These symbols may not be displayed on the normal virtual letter keyboard. However, in certain embodiments of the invention, the users will be able to change the layout of the virtual keyboard which is used as the basis against which different taps are mapped to specific letters, punctuation marks and symbols. With reference to FIG. 15, in an embodiment, a symbol or any other virtual keyboard 106 can be displayed after the user performs an up-bound swipe gesture (1) 221 commencing at or near some edge of the input device 100 rather than in the main portion of the touchpad 106 over any of the keys. Since many electronic devices include accelerometers that detect the position of the device 100, the position of the keyboard 106 and lower edge of the device 100 can change depending upon how the device 100 is being held by the user. In order to simplify the lower edge area, the system may have a predefined edge region 225 around the entire device 100. When the system detects swipe commencing in the predefined edge region 225, the system can replace the virtual letter keyboard map with a different one, such as a number keyboard 106 shown. Subsequent keyboard change gestures 221 may result in additional alternative keyboards being displayed such as symbols, etc. Thus, the system can distinguish edge swipes 221 that start from the predefined edge region 225 from normal swipes that are commenced over the virtual keyboard 106 or main display area 103. As discussed above with reference to FIG. 7, the touch screen display 103 may have an outer region 225 that can be a predetermined with around the perimeter of the display 103. By detecting swipes that originate in the outer region 225, the system can distinguish edge swipes from center display 103 swipes.

In some embodiments, this up-bound gesture may invoke different keyboards in a repeating rotation. For example, system may include three keyboards which are changed as described above. The “normal” letter character keyboard may be the default keyboard. The normal keyboard can be changed to a numeric keyboard, which may in turn be changed to a symbol keyboard. The system may include any number of additional keyboards. After the last keyboard is displayed, the keyboard change swipe may cause the keyboard to be changed back to the first normal letter character keyboard. The keyboard switching cycle can be repeated as necessary. In an embodiment, the user can configure the system to include any type of keyboards. For example, there are many keyboards for different typing languages.

In other embodiments, the location of the swipe, or the specific location may control the way that the keyboard is changed by the system. For example, a swipe from the left may invoke symbol and number keyboards while a swipe from the right may invoke the different language keyboards. In yet another embodiment, the speed of the keyboard change swipe may control the type of keyboard displayed by the system.

Once the keyboard has been changed to a non-letter configuration, the taps of the user will be interpreted against the new keyboard reference. In the example of FIG. 15, the user has tapped the desired text, “The text correction system is fully compatible with the iPad” 227. The user then inputs a swipe up 221 from the bottom of the screen in the predefined edge region 225 indicated by Line 1 to change the virtual keyboard from a letter keyboard to a number and symbols keyboard 106. Once the number and symbols keyboard 106 is displayed, the user taps on the “!” 229 designated by reference number 2 to add the exclamation mark ! 230 at the end of the text sentence. The output reflects the effect of the swipe 221 to change the keyboard to number and symbols keyboard 106. The system will not attempt to automatically correct any such entry of symbols, and thus the user is required to be precise in this case.

### Function Key Controls

In certain embodiments of the device, an “advanced entry” mode may be present. This may enhance the layout of the virtual keyboard, so that upon a certain gesture could make certain function keys visible and operable. For example, a “press and hold” gesture may be used to make the function keys visible and operable. Where the user places a finger anywhere on the virtual keyboard, and holds the finger in a fixed position for a predetermined period of time the user interface system can respond by making additional function keys visible and operable. In these embodiments, the basic keyboard keys will remain operable and visible, but additional keys would be presented in areas that were previously inactive, or in areas that were not taken up by the on-screen keyboard.

When the user interface detects the press and hold, the system can respond by displaying the additional function keys on and around the keyboard display. Once displayed, the user can actuate any of these function keys by moving their finger to these newly display function keys while still maintaining contact with the screen. In other embodiments, once the new function keys are displayed, the user can tap on the break contact with the screen and tap any of the newly displayed function keys.

These normally hidden function keys can be any keys that are not part of the normally displayed keyboard. For example, these function keys can include punctuation marks, numbers, or symbols. These function keys may also be used for common keyboard buttons such as “shift” or “caps lock” or “return”. A benefit of this approach is that these function keys would not be accidentally pressed while typing, but could be invoked and pressed with a simple gesture such as pressing anywhere on the keyboard for a period of time. So, a virtual keyboard could omit the “numbers” row during regular typing, but display it above the keyboard after this gesture.

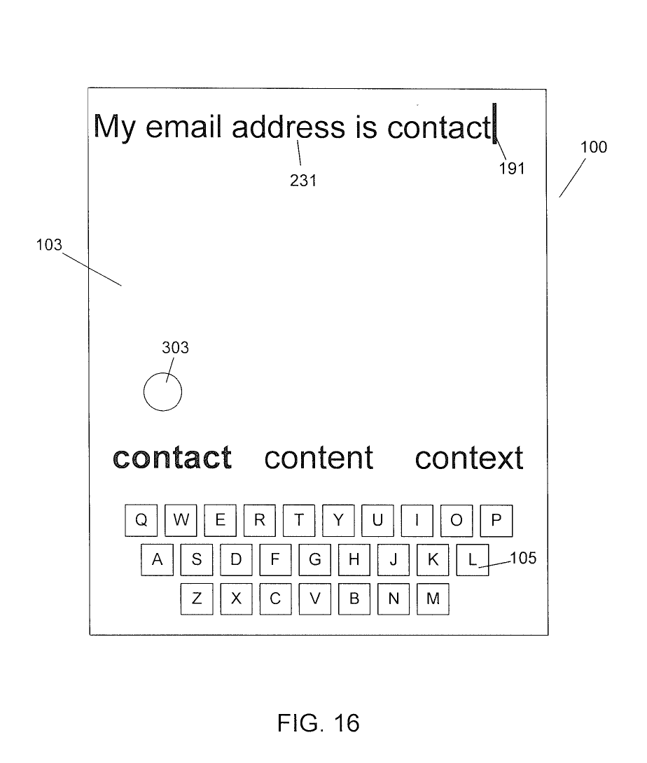

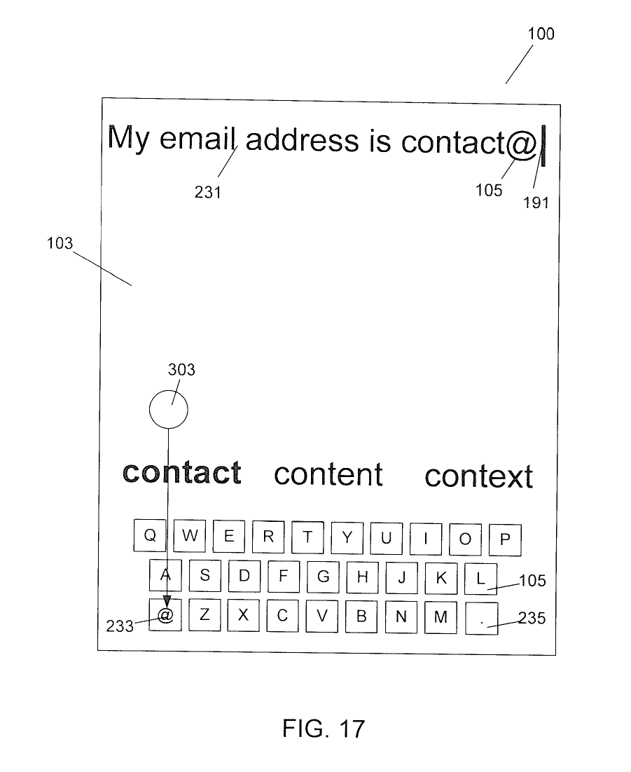

An example of this system is illustrated in FIGS. 16 and 17. FIG. 16 illustrates a mobile device with a touch screen input 103 and a keyboard 105 displayed on the touch screen 103. The user has input text and would like to add the “@” symbol at the end of the text “My email address is contact” 231 followed by the cursor 191. In order to display the “@,” key, the user touches and holds a spot 303 with a finger on the touch screen 103. With reference to FIG. 17, when the user interface detects the user's touch and hold gesture, the system responds by displaying the “@” key 233 on the lower left side and the “.” key 235 on the lower right side of the keyboard 105. The user can then move the finger to tap the “@” key and the “@;” symbol 239 is displayed after the input text 231. In other embodiments, any other symbol or function keys can be displayed on or adjacent to the keyboard 105 in response to the described touch and hold gesture.

In order to avoid accidentally displaying the function keys, the predetermined time period should not be so short that the press and hold gesture can be accidentally actuated. For example, the user interface may require that the touch and hold be 1 second or more. However, this time period should not be so long that it causes significant user input delays. In an embodiment, the user may be able to adjust this time period so that this feature functions with the user's personal input style both accurately and efficiently.

In an embodiment, the system can scroll through a set of symbol, function and/or other keys. For example, a user wants to input a specific symbol, the symbols function can be initiated in the manner described above. This may result in the “@” symbol being displayed. The user can then swipe up or down, as described above when selecting a desired word, to see other alternative symbols. The system can change the displayed symbol in response to each of the user's scrolling swipes. After the desired symbol is displayed, the user can press and hold the screen to cause the system to display an additional key on the virtual keyboard. For example, the system may add the “$” symbol key. When a user selects the “$” key, the user can make swipe up or down to get other currency symbols such as foreign currency symbols.

### Common Punctuation Entry

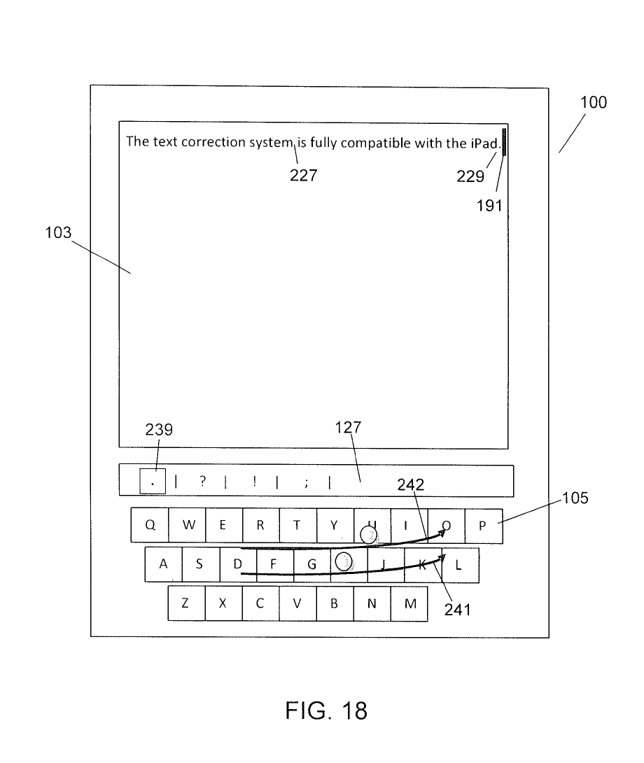

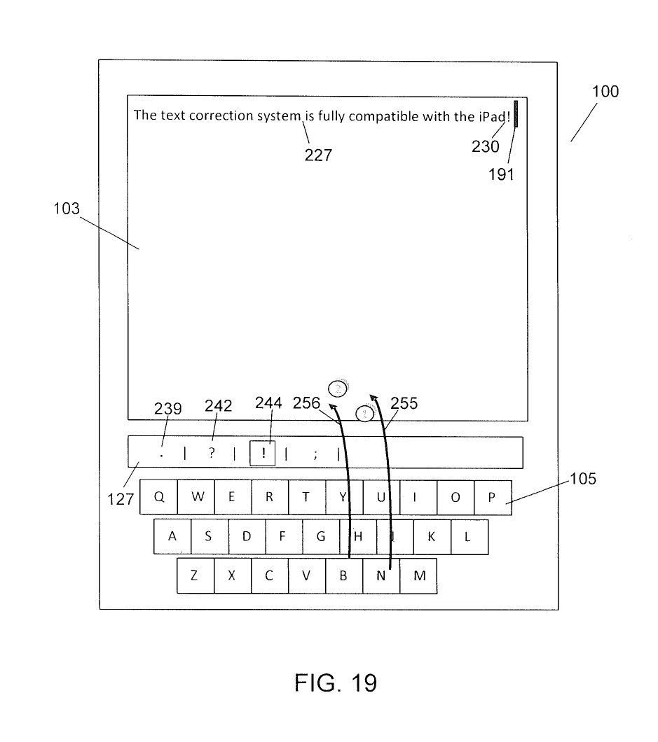

In embodiments of the invention, the system may include shorter and more efficient way to enter some of the more common punctuation marks or other commonly used symbols. This additional input method may also allow for imprecise input. With reference to FIG. 18, the punctuation procedure can commence when the system is in a state where the user has just input text 227 and input a first right swipe 241 designated by line l to indicate a complete word and space. If the user then performs a second right swipe 242 designated by line 2 before tapping on the screen 103 for additional text in the next sentence, the system will insert a period 229 punctuation mark after the text 227. At this point, the period 329 is also displayed in the possible area 127 with other punctuation marks may be offered as alternative suggestions. The period “.” 239 is highlighted and the user may navigate through the other punctuation marks in the possible area 127 using the up/down swipe gestures described above. In this example, the suggested punctuation period “.” 239 is outlined. It may be difficult to clearly see the suggested or current punctuation mark bold text. Thus, another highlighting method can be outlining as illustrated around the period 239. With reference to FIG. 19, if the user performs two sequential up swipe gestures 255, 256 designated by lines 1 and 2, the system will replace the “.” with a exclamation “!” 230 punctuation mark. The system will first highlight the “?” 242 after the first up swipe 255 and then highlight the “!” 244 after the second up swipe 256. The “!” 230 will simultaneously be displayed after the text 227 in the display

### Advanced Keyboard Functions

In other embodiments, the system can recognize certain gestures for quickly changing the layout of the keyboard without having to invoke any external settings menus or adding any special function keys. Any of the above describes gestures including a swipe from the bottom of the screen which may be used to invoke alternative number and symbol keyboards as described. Alternative functions can be implemented by performing swipes with two or more fingers. For example, a two fingers upwards swipe starting from the bottom half of the screen or within the virtual keyboard boundaries could invoke alternative layouts of the keyboard, such as alternative typing languages.

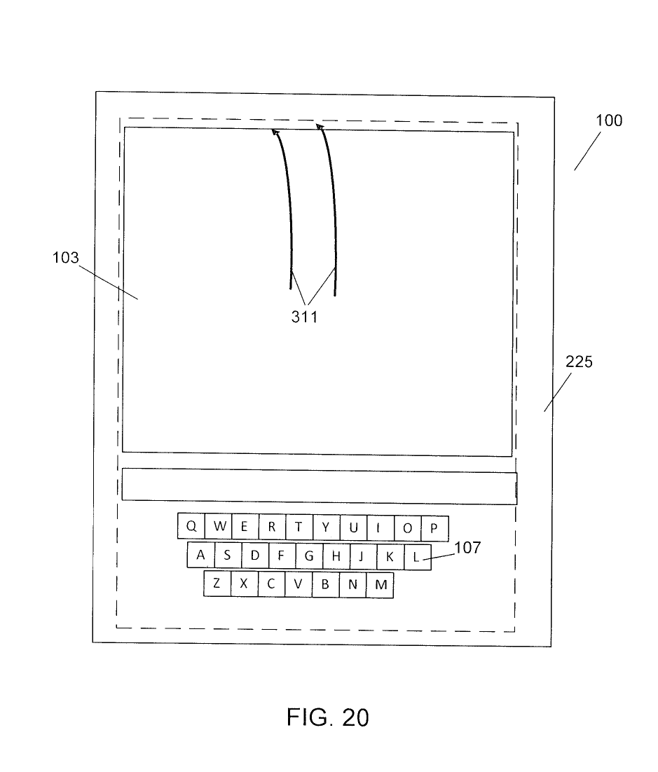

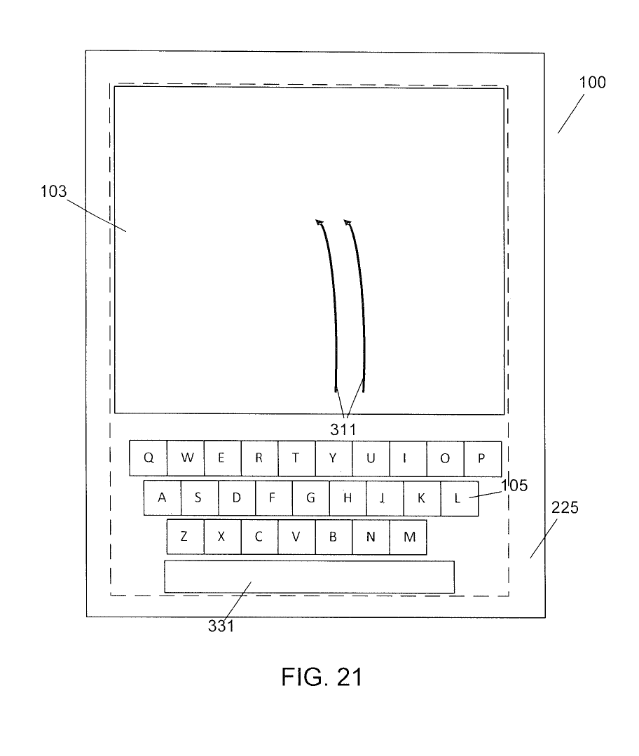

With reference to FIG. 20, in an embodiment a swipe 311 performed with two fingers in an upwards trajectory starting from the top half of the screen 103 could be used to resize the keyboard 105. In this example, the keyboard 107 is smaller as a result of the two finger swipe 311. In an embodiment, the size of the keyboard 107 can be controlled by the length of the swipe 311. A short up swipe can cause a slight reduction in the size of the keyboard 107 and a long swipe 311 can cause a much smaller size keyboard 107. Conversely, a two finger downward swipe can cause the keyboard to become enlarged. Alternatively, with reference to FIG. 21, a two finger swipe 311 in an upwards trajectory could show or hide some additional function keys. For example, the swipe 311 could add a space button 331 to a keyboard 105, which could be removed by the opposite, downwards two finger swipe. When the space button 331 is shown on the keyboard 105, the right bound swipe gesture may also be available for typing a space character as described above or this feature may be automatically turned off. Again, it may be possible to distinguish two finger swipes based upon the location of the beginning or end of the swipe. In different embodiments, the system can distinguish swipes starting or ending in the boundary area 225 as well as the upper or lower halves of the screen 103.

### Use of Hardware Buttons

The present invention may also be applied to devices which include some hardware keys as well as soft, virtual keys displayed on a touch screen. This would enable the application of certain functionality using the hardware keys, which may be particularly useful to users with impaired vision. Additionally, where the invention is retrofitted to an existing device, hardware keys could be re-programmed to perform specific typing functions when the user is operating within a text input context.

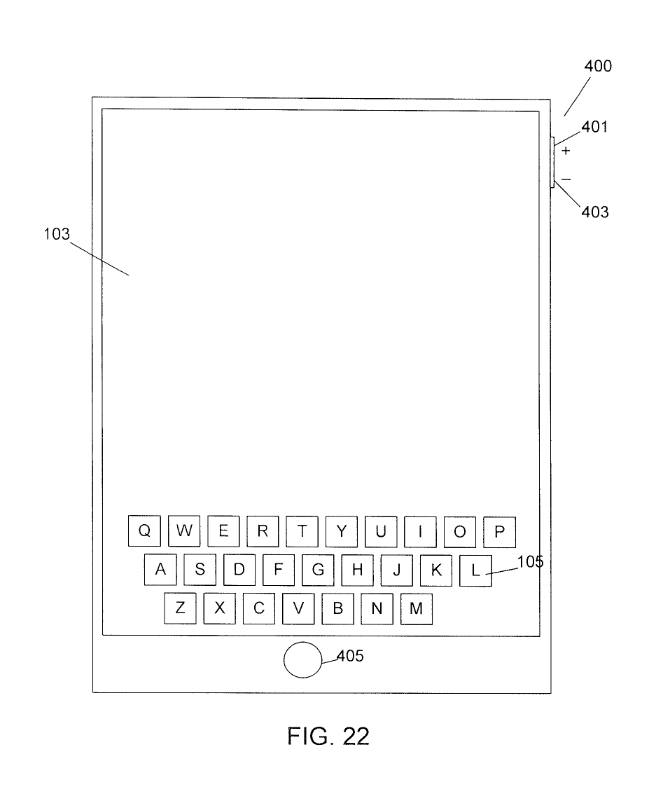

Most mobile telephones include a hardware key for adjusting the speaker volume up and down. With reference to FIG. 22, this same hardware key or any other hardware key on the mobile phone 400 could be used to perform system input functions. For example, in an embodiment, a hardware key 401 can change the capitalisation of text input, or to switch between different keyboard layouts as described above with reference to FIG. 15. Alternatively, the hardware key can be used to cycle between the system correction suggestions. For example, the + volume key 401 could cause scrolling or cycling forward and the − volume key 403 can cause scrolling or cycling backwards. Other common buttons such as a “home” button 405, also commonly present in many mobile devices could be used to emulate the space button, similar to the effects of the right bound swipe described.

### Accessibility Mode—Audio Output

The system may use a device other than a screen to provide the feedback to the user. For instance, the present invention may be employed with an audio output device such as speakers or headphones. In certain embodiments of the invention, the user will type using the usual tap gestures. The device may provide audible signals for each tap gesture. Once a rightwards swipe is given by the user, the system will correct the input and read back the correction using audio output. The user may then apply the upwards/downwards swipe gestures to change the correction with the next or previous suggestion, also to be read via audio output after each gesture. Such an embodiment may allow use of the invention by visually impaired user, or may enable its application in devices without screens, or by users who prefer to type without looking at the screen.

In an embodiment, the inventive system may include an audio output and may also provide audio feedback for some or all of the additional functions described above. For instance, the deletion of words as described with reference to FIG. 13 could be announced with a special sound, and deletion of characters as shown in FIG. 11 could be indicated with a different sound. Many mobile devices such as cell phones also have a vibration feature that can be used by the inventive system to provide motion feedback when text input functions are actuated. In other embodiments, a variety of sounds and/or vibrating feedback could be used in response to different swiping gestures input by the user and detected by the inventive system.

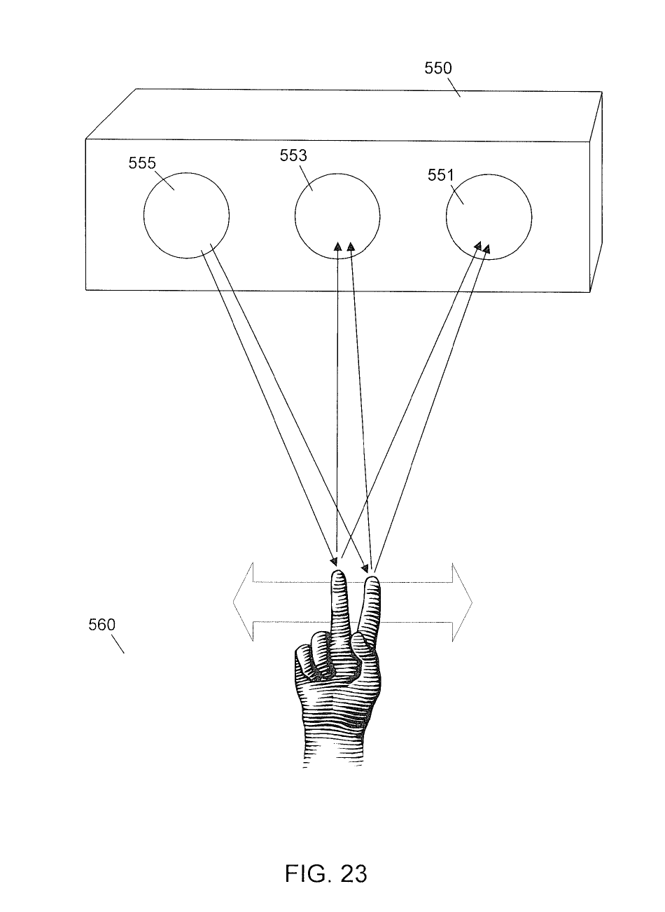

With reference to FIG. 23, in an embodiment body movement or finger gestures of a user can be obtained using an optical device comprising an image camera 551, an infrared (IR) camera 553 and an infrared (IR) light source 555 coupled to a signal processor. The IR light source 555, IR camera 553 and an image camera 551 can all be mounted on one side of the optical device 550 so that the image camera 551 and IR camera 553 have substantially the same field of view and the IR light source 551 projects light within this same field of view. The ER light source 555, IR camera 553 and image camera 551 can be mounted at fixed and known distances from each other on the optical device 550. The image camera 551 can provide information for the patient's limb 560 or portion of the patient within the viewing region of the camera 551. The IR camera 553 and IR light source 555 can provide distance information for each area of the patient's limb or digits 560 exposed to the IR light source 555 that is within the viewing region of the IR camera 553. The infrared light source 555 can include an infrared laser diode and a diffuser. The laser diode can direct an infrared light beam at the diffuser causing a pseudo random speckle or structured light pattern to be projected onto the user's body 560. The diffuser can be a diffraction grating which can be a computer-generated hologram (CGH) with a specific periodic structure. The IR camera 553 sensor can be a CMOS detector with a band-pass filter centered at the IR laser wavelength. In an embodiment, the image camera 551 can also detect the IR light projected onto the user's limbs, hands or digits 560.

In an embodiment the system may include a user interface that allows a user to configure the inventive system to the desired operation. The described functions can be listed on a settings user interface and each function may be turned on or off by the user. This can allow the user to customize the system to optimize inputs through the touch screen of the electronic device.

It will be understood that the inventive system has been described with reference to particular embodiments, however additions, deletions and changes could be made to these embodiments without departing from the scope of the inventive system. Although the order filling apparatus and method have been described include various components, it is well understood that these components and the described configuration can be modified and rearranged in various other configurations.

What is claimed is:

1. A method, comprising:
a computer system having a processor operatively coupled to a memory, a touch interface, the touch interface comprising a virtual keyboard which records taps of a touch object to generate text input:
detecting swipe gestures across the touch interface, the swipe gesture including an initial touchdown point and a direction;
determining the directions of the swipe gestures; and
performing predetermined functions determined by the direction of the swipe gestures, wherein:
a correction initiation input to the computer system causes a listing of suggested replacement texts to be generated with a ^{.}first of the suggested replacement text indicated;
a subsequent swipe gesture in a first direction on the touch interface causes the next suggested replacement text from the listing to be indicated;
a subsequent swipe in a second direction on the touch interface causes the previous suggested text from the listing to be indicated.

2. The method of claim 1 wherein the correction initiation input is an upward swipe gesture on the touch interface.

3. The method of claim 1 wherein the correction initiation input is a right swipe gesture on the touch interface.

4. The method of claim 1 wherein the computer system includes a physical correction button and the correction initiation input is a first actuation of the physical correction button.

5. The method of claim 1 wherein the correction initiation input is a tap on a virtual correction initiation button on the touch interface.

6. The method of claim 1 wherein the first direction is up and the second direction is down.

7. The method of claim 1 wherein the first direction is down and the second direction is up.

8. The method of claim 1 wherein the first direction is right and the second direction is left.

9. The method of claim 1 wherein the first direction is left and the second direction is right.

10. The method of claim 1 wherein the first direction is clockwise rotational movement and the second direction is counter clockwise rotational movement.

11. The method of claim 1 wherein the first direction is counter clockwise rotational movement and the second direction is clockwise rotational movement.

12. The method of claim 1 wherein a correction completion input to the computer system causes the indicated text to replace the generated text input and subsequent text to be input.

13. The method of claim 12 wherein the correction completion input is an upward swipe gesture on the touch interface.

14. The method of claim 12 wherein the correction completion input is a right swipe gesture on the touch interface.

15. The method of claim 12 wherein the correction completion input is a tap gesture on the touch interface.

16. The method of claim 12 wherein the computer system includes a physical correction button and the correction completion input is an actuation of the physical correction button.

17. The method of claim 1 wherein the indication of a suggested replacement text causes the suggested replacement text to become the generated text input.

18. The method of claim 1 wherein the listing of suggested replacement text generated is displayed on a computer screen.

19. The method of claim 1 wherein the indicated replacement text is displayed on a computer screen.

20. The method of claim 1 wherein the computer system comprises an audio output and the computer emits an audio representation of the suggested replacement text currently being indicated.

21. The method of claim 1 wherein the computer system comprises an audio output and the computer emits an audio correction initiation signal indicating that the correction initiation has been invoked.

22. The method of claim 1 wherein the computer system comprises an audio output and the computer emits an audio correction signal indicating that the suggested replacement text being indicated has replaced the generated text input.

23. A method, comprising:
a computer system having a processor operatively coupled to a memory, a touch interface, the touch interface comprising a virtual keyboard which records taps of a touch object to generate text input:
detecting a touch and hold gesture on the touch interface for a predetermined period of time;
displaying a predetermined function key at an area of the screen which was previously not active typing area; and
maintaining the visibility and functionality of the keyboard in its current state before the detection of the touch and hold gesture.

24. The method of claim 23 wherein the predetermined function key is a number key.

25. The method of claim 23 wherein the predetermined function key is a symbol key.

26. The method of claim 23 wherein the predetermined function key is a symbol key selected from the group consisting of @, ! and ?.

27. The method of claim 23 wherein the predetermined function key is a control key selected from the group consisting of backspace, shift, caps lock and return.

28. The method of claim 23 further comprising:
actuating the predetermined function key.
